(19) United States
(12) Patent Application Publication
(10) Pub. No.: US 2026/0186844 A1
(43) Pub. Date: Jul. 2, 2026

(54) TIME-SERIES DATA PROCESSING DEVICE AND TIME-SERIES DATA PROCESSING METHOD

(71) Applicant: Mitsubishi Electric Corporation, Tokyo (JP)

(72) Inventor: Daichi ARIMIZU, Tokyo (JP)

(73) Assignee: Mitsubishi Electric Corporation, Tokyo (JP)

(21) Appl. No.: 19/548,340

(22) Filed: Feb. 24, 2026

Related U.S. Application Data
(63) Continuation of application No. PCT/JP2023/037945, filed on Oct. 20, 2023.

(51) Int. Cl. G06F 9/50

(52) U.S. Cl. CPC G06F 9/5027

(57) ABSTRACT

A time-series data processing device includes: a data input unit to acquire a first time-series dataset including a plurality of time-series data to be treated as explanatory-variable candidates; a preprocessing unit to convert the acquired first time-series dataset into a format capable of calculating relationships between the time-series data included in the first time-series dataset, and generate a second time-series dataset including the plurality of time-series data after the conversion; a relationship calculation unit to calculate waveform and semantic relationships between the time-series data included in the second time-series dataset; a stratification unit to determine temporal relationships between the time-series data included in the second time-series dataset, stratify the time-series data included in the second time-series dataset according to the determined temporal relationships, and output a result of the stratification; and a visualization unit to generate a visualization diagram visualizing the time-series data included in the second time-series dataset.

### CROSS REFERENCE TO RELATED APPLICATION

This application is a Continuation of PCT International Application No. PCT/JP2023/037945, filed on Oct. 20, 2023, which is hereby expressly incorporated by reference into the present application.

### TECHNICAL FIELD

The present disclosure relates to a time-series data processing technology.

### BACKGROUND ART

In time-series data processing using a prediction model, the selection of explanatory variables is extremely important and significantly affects the precision of prediction. However, it is difficult to manually select optimum explanatory variables from a large number of explanatory-variable candidates. Accordingly, there are technologies proposed to automatically perform the selection/elimination of explanatory variables in prediction according to an algorithm specified in advance (e.g. Patent Literature 1). In the technology according to Patent Literature 1, the selection/elimination of explanatory variables is automatically performed by comparing (the absolute values of) the regression coefficients between the response variable and the explanatory variables with a threshold, assuming that explanatory variables with greater regression coefficients are more appropriate (claim 4 and paragraph 0093 in Patent Literature 1).

### CITATION LIST

### Patent Literature

Patent Literature 1: WO 2013/187295

### SUMMARY OF INVENTION

### Technical Problem

According to the technology disclosed in Patent Literature 1 in which the selection/elimination of explanatory variables is automatically performed, there is a problem that only explanatory variables that exhibit spurious correlation with the response variable are selected, in some cases. That is, there is a problem that explanatory variables that cannot be said to have a causal relation with the response variable are determined to have a causal relation due to some factor, and only such explanatory variables are selected, in some cases.

The present disclosure has been made to solve such a problem, and an object thereof is to provide a time-series data processing technology capable of preventing the selection of only explanatory variables that exhibit spurious correlation.

### Solution to Problem

One aspect of a time-series data processing device according to an embodiment of the present disclosure includes: processing circuitry to acquire a first time-series dataset including a plurality of pieces of time-series data to be treated as explanatory-variable candidates; to convert the acquired first time-series dataset into a format capable of calculating relationships between the plurality of pieces of time-series data included in the first time-series dataset, and generate a second time-series dataset including the plurality of pieces of time-series data after the conversion; to calculate waveform and semantic relationships between the plurality of pieces of time-series data included in the second time-series dataset; to determine temporal relationships between the plurality of pieces of time-series data included in the second time-series dataset, stratify the plurality of pieces of time-series data included in the second time-series dataset according to the determined temporal relationships, and output a result of the stratification; and to generate a visualization diagram visualizing the plurality of pieces of time-series data included in the second time-series dataset on a basis of the calculated waveform and semantic relationships and the output result of the stratification.

### Advantageous Effects of Invention

The time-series data processing device according to the embodiment of the present disclosure presents a plurality of explanatory-variable candidates, thereby making it possible to prevent the selection of only explanatory variables that exhibit spurious correlation.

### BRIEF DESCRIPTION OF DRAWINGS

FIG. 1 is a drawing illustrating a configuration example of a time-series data processing device and a time-series data processing system.

FIG. 2 is a schematic drawing illustrating a process performed by a grouping unit.

FIG. 3 is a drawing illustrating an overview of relationship calculation performed by a relationship calculation unit.

FIG. 4 is a drawing illustrating an overview of stratification performed by a stratification unit.

FIGS. 5A and 5B are drawings illustrating a variation of the stratification. Specifically, FIGS. 5A and 5B are drawings illustrating an example of month-shifted correlation. FIG. 5A is a drawing illustrating original waveforms. FIG. 5B is a drawing illustrating a case where one waveform is shifted by one month.

FIG. 6 is a drawing illustrating a variation of the stratification. Specifically, FIG. 6 is a drawing illustrating a specific example of a case where the stratification is performed according to preset temporal relationships.

FIG. 7A is a drawing illustrating a configuration example of the hardware of the time-series data processing device.

FIG. 7B is a drawing illustrating a configuration example of the hardware of the time-series data processing device.

FIG. 8 is a flowchart of a time-series data processing method.

FIG. 9 is a drawing illustrating an example of a visualization diagram.

FIG. 10 is a drawing illustrating an overview of a process performed by a recalculation unit.

### DESCRIPTION OF EMBODIMENTS

Hereinbelow, various embodiments according to the present disclosure are explained in detail with reference to the attached drawings. Note that constituent elements that are given identical or similar reference characters in the drawings are constituent elements having identical or similar configurations or functions, and overlapping explanations of such constituent elements are omitted. In addition, unless otherwise specified, in the present disclosure, the term “or” is used in the meaning of an inclusive logical disjunction.

In addition, a “causal relation” used in the present disclosure means one selected by a user from among temporal relationships determined through statistical analysis between two pieces of time-series data. The user selects a temporally ordered relation which is convincing to the user.

### First Embodiment

### <Configuration>

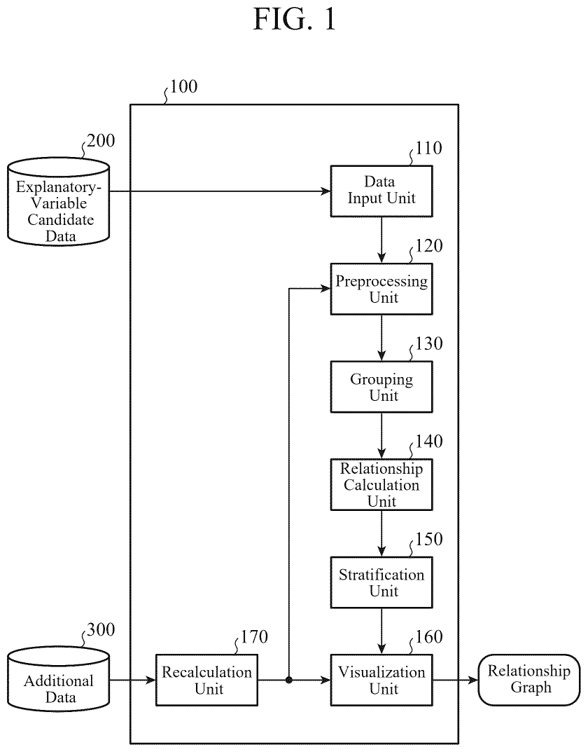

A time-series data processing device and a time-series data processing system according to a first embodiment of the present disclosure are explained with reference to FIG. 1. The time-series data processing system illustrated in FIG. 1 includes a time-series data processing device 100, a storage device 200, and a storage device 300. The storage device 200 is a device to store time-series data to be treated as explanatory-variable candidates. The storage device 300 is a device to store additional data.

### (Time-Series Data Processing Device)

The time-series data processing device 100 includes: a data input unit 110 to acquire a first time-series dataset including a plurality of pieces of time-series data to be treated as explanatory-variable candidates from the storage device 200; a preprocessing unit 120 to convert the acquired first time-series dataset into a format capable of calculating relationships between the plurality of pieces of time-series data included in the first time-series dataset, and generate a second time-series dataset including the plurality of pieces of time-series data after the conversion; a grouping unit 130 to classify the plurality of pieces of time-series data included in the second time-series dataset into groups according to the nature of the plurality of pieces of time-series data and generate a representative value of each group; a relationship calculation unit 140 to calculate waveform and semantic relationships between the plurality of pieces of time-series data included in the second time-series dataset; a stratification unit 150 to determine temporal relationships between the plurality of pieces of time-series data included in the second time-series dataset, stratify the plurality of pieces of time-series data included in the second time-series dataset according to the determined temporal relationships, and output a result of the stratification; a visualization unit 160 to generate a visualization diagram visualizing the plurality of pieces of time-series data included in the second time-series dataset on the basis of the calculated waveform and semantic relationships and the output result of the stratification; and a recalculation unit 170 to accept additional time-series data and perform recalculation for adding the accepted additional time-series data to the visualization diagram.

### (Data Input Unit)

The data input unit 110 acquires a time-series dataset (first time-series dataset) D1 including a plurality of pieces of time-series data to be treated as preceding indicator candidates. From among the preceding indicator candidates, a preceding indicator to be used for prediction of a future indicator or time-series data of the preceding indicator is selected. For example, an example of the prediction is a future indicator such as the air conditioner shipment volume.

Hereinafter, the purpose of the time-series data processing device 100 and the time-series data processing system of the present disclosure is explained in more detail. For this purpose, a case is considered where the amount of apple consumption is used as an explanatory variable when it is desired to predict the air conditioner shipment volume. Even if this prediction succeeds, it is difficult to find a causal relation between the “amount of apple consumption” and the “air conditioner shipment volume” from domain knowledge. Accordingly, there is a possibility that the prediction result in this case is not convincing to a user of the time-series data processing device 100 and causes the user to feel distrust.

In contrast, a case is considered where the number of new building construction starts is used for explanation when predicting the air conditioner shipment volume. In this case, it has been known from domain knowledge that there is a causal relation: “The number of buildings increases. →The demand for air conditioners to be newly installed in the buildings increases. →The air conditioner shipment volume increases.” Accordingly, the prediction result in this case is likely to be convincing to the user.

The selection of explanatory variables that is convincing to the user is difficult to achieve through statistical assessment alone, and manual assessment is essential in the end. On the other hand, for example, there are hundreds of thousands of types of economic indicator data used in product demand prediction, and it is extremely difficult to manually select explanatory variables which are valid both in terms of domain knowledge and statistically from such a large number of pieces of data.

An object of the time-series data processing device 100 and the time-series data processing system of the present disclosure is to make a method of selecting/eliminating explanatory variables convincing to the user, and to reduce the sense of distrust of the method regarding prediction, by improving the method. The user's sense of satisfaction is the meaning of causal relations between a plurality of indicators.

The explanation returns to the data input unit 110. It is assumed that the time-series dataset D1 includes a plurality of time-series datasets, and each time-series dataset is given a name representing what data it is. In addition, it is assumed that the time series of all of the plurality of time-series datasets included in the time-series dataset D1 shares the same unit. For example, it is assumed that all of the plurality of time-series datasets of the time-series dataset D1 are monthly data, yearly data, or the like sharing the same unit. The data input unit 110 supplies the acquired time-series dataset D1 to the preprocessing unit 120.

### (Preprocessing Unit)

The preprocessing unit 120 is a functional unit to perform data preprocessing on the time-series dataset D1 acquired at the data input unit 110 to generate a time-series dataset D2 and output the generated time-series dataset D2 to the grouping unit 130. That is, the preprocessing unit 120 converts the acquired time-series dataset D1 into a format capable of calculating relationships between the plurality of pieces of time-series data included in the time-series dataset D1 and generates the second time-series dataset including the plurality of pieces of time-series data after the conversion. The data preprocessing specifically includes a process related to missing values and a process related to standardization of data and the like.

### (Grouping Unit)

The grouping unit 130 is a functional unit to classify the time-series dataset D2 into a plurality of groups according to the nature of each piece of data, generate a representative value of each group, gives information thereof (representative value) to the group, and outputs, to the relationship calculation unit 140, a group D3 after the representative value is given.

More specifically, the grouping unit 130 first performs clustering on the time-series dataset D2 obtained from the preprocessing unit 120 on the basis of the degrees of similarity between waveforms, the degrees of similarity between names, and the like. Clusters obtained as a result of the clustering are treated as groups, and thereafter data processing is to be performed treating the groups as units. Next, the generation of a representative value reflecting features of each group is performed so as to handle each group as time-series data.

In the first embodiment, the classification of the time-series dataset D2 is performed in the following manner. First, according to the following Formula (1), cross-correlation is calculated in a state where the time series of each piece of data is aligned. Next, pieces of data with a coefficient of correlation equal to or greater than a certain value (predefined; D3-N1) are classified into the same group. It is assumed that each group includes information about a name list (D3-1) of pieces of data included in the group.

$$r = \frac{{\sum }_{i} ( {x}_{i} - \overline{x} ) ( {y}_{i} - \overline{y} )}{\sqrt{{\sum }_{i} {( {x}_{i} - \overline{x} )}^{2} {\sum }_{i} {( {y}_{i} - \overline{y} )}^{2}}} \qquad ( 1 )$$

It should be noted that the index i represents a date/time t, and, for example, t=January 1st, February 1st, March 1st, . . . , December 1st.

In addition, the generation of representative values is performed in the following manner. The period for the representative value of each group is a period from the oldest time point to the newest time point of data included in the group, and this is treated as a period T1. In addition, the average value of values of data at each time point in the period T1 included in the group is treated as a representative value of the group at the time point. In this manner, a representative value reflecting features of data included in each group can be generated. It is assumed that the groups D3 include information (D3-2) about the representative values.

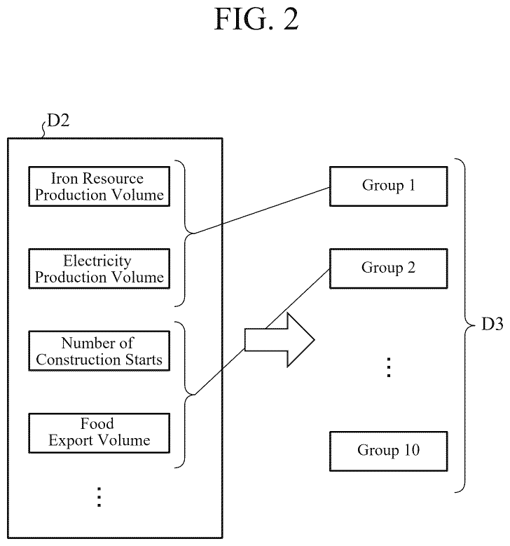

FIG. 2 is a schematic drawing illustrating a process performed by the grouping unit 130. As illustrated in FIG. 2, the time-series dataset D2 includes a plurality of time-series datasets such as a time-series dataset “iron resource production volume,” a time-series dataset “electricity production volume,” a time-series dataset “number of construction starts,” and a time-series dataset “food export volume.” The grouping unit 130 performs grouping of the plurality of time-series datasets included in the time-series dataset D2 according to the nature of data. FIG. 2 illustrates a state where the time-series datasets “iron resource production volume” and “electricity production volume” are classified into a group 1, and the time-series datasets “number of construction starts” and “food export volume” are classified into a group 2. In this manner, the time-series datasets are classified into groups, and each group after the classification is referred to as a group D3.

### (Relationship Calculation Unit)

The relationship calculation unit 140 is a functional unit to calculate inter-group relationships (waveform and semantic relationships) D4 between the groups D3 generated by the grouping unit 130, and output information about the relationships D4 and the groups D3 to the stratification unit 150. More specifically, the relationships between a plurality of the groups D3 are calculated using representative values of the respective groups. The inter-group relationships include information about the degrees of inter-group waveform similarity (D4-1). Waveform and semantic relationships mean waveform relationships or semantic relationships. Waveform relationships are indicators representing to what degrees the waveforms of data are similar to each other. For example, semantic relationships are the depths of the degrees of association between data that can be defined by domain knowledge or the like. As a specific example of semantic relationships, for example, even if the waveforms of data of the air conditioner demand volume and data of the average temperature are not similar to each other, it can be known from domain knowledge that the data of the air conditioner demand volume and the data of the average temperature obviously have a relationship, in some cases.

In the first embodiment, the calculation of inter-group relationships is performed in the following manner. Since a representative value of each group can be handled as time-series data, relationships are defined by the magnitude of the coefficients of cross-correlation between the data, similarly to the process performed by the grouping unit 130. It should be noted that, at the time of the calculation of cross-correlation at the relationship calculation unit, the calculation is performed using data that is obtained by time-shifting the representative values of groups forward and backward by up to +N (predefined integer; for example, 12) in one-month increments, and the largest coefficient of correlation among the calculated coefficients of correlation is treated as the degree of waveform similarity (D4-1) between the groups. In addition, the time shift width at that time is treated as a temporal precedence relation (D4-2) between the groups.

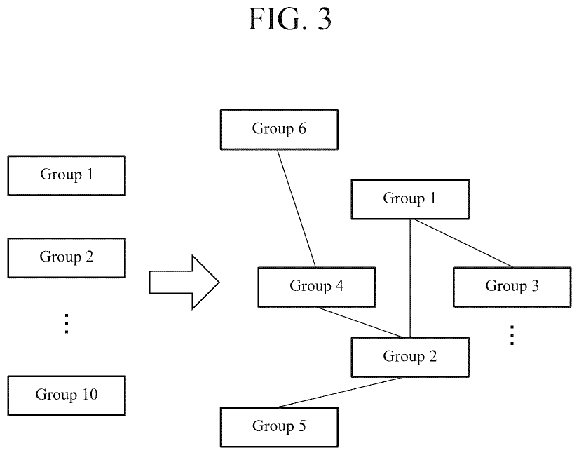

FIG. 3 is a drawing illustrating an overview of the relationship calculation performed by the relationship calculation unit 140. As illustrated in FIG. 3, the relationships D4 between the plurality of groups D3 are calculated, and groups with strong relationships are connected by lines according to the result of the calculation. In FIG. 3, a group 1 has strong relationships with a group 2 and a group 3, and the group 1 is connected with the group 2 and the group 3 by lines. In addition to the group 1, the group 2 has strong relationships also with a group 4 and a group 5, and the group 2 is connected also with the group 4 and the group 5 by lines. In addition to the group 2, the group 4 has a strong relationship also with a group 6, and the group 4 is connected also with the group 6 by a line.

### (Stratification Unit)

The stratification unit 150 is a functional unit to determine temporal relationships between the plurality of pieces of time-series data included in the time-series dataset D2, stratify the plurality of pieces of time-series data included in the time-series dataset D2 according to the determined temporal relationships, and output the result of the stratification.

The stratification unit 150 may treat the plurality of groups D3 generated by the grouping unit 130 as processing targets. In this case, the stratification unit 150 determines temporal relationships between the plurality of groups D3, stratifies the plurality of groups D3 according to the determined temporal relationships, and outputs the result of the stratification.

A more detailed explanation is given about a case where the stratification unit 150 treats the plurality of groups D3 as processing targets. In order to clarify causal relations between the plurality of groups D3, the stratification unit 150 specifies temporal relationships between the groups D3 on the basis of the step order of various activities or statistical analysis such as month-shifted correlation and gives information (D3-3) about the temporal relationships to the groups D3.

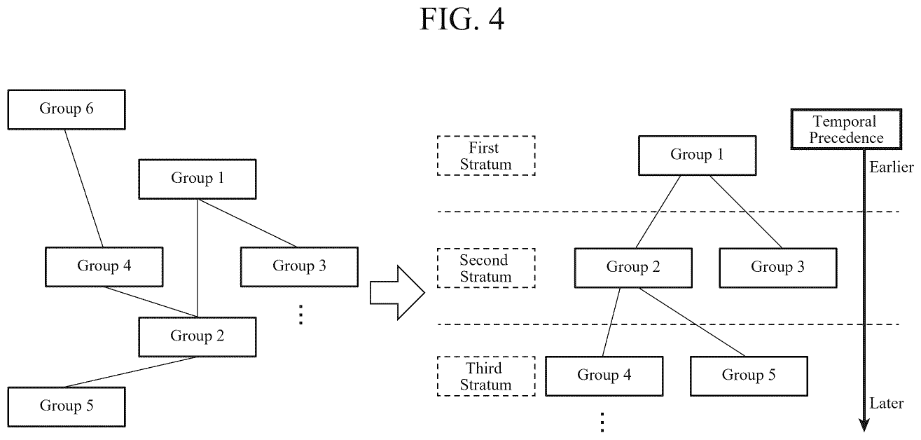

FIG. 4 is a drawing illustrating an overview of an example of the stratification performed by the stratification unit 150. As illustrated in FIG. 4, the stratification unit 150 rearranges the groups D3 linked by the relationship calculation unit 140 stratifically according to the temporal relationships. The example of stratification in FIG. 4 illustrates that the group 2 temporally precedes the group 4 and the group 5, and the group 1 temporally precedes the group 2 and the group 3.

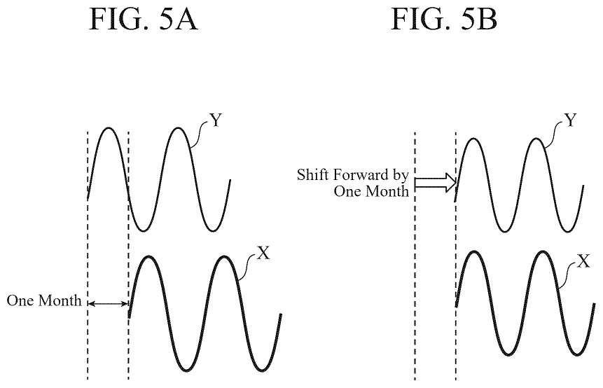

As an example, in the first embodiment, the generation of strata (temporal relationships) of the groups is performed in the following manner. That is, time-series data is time-shifted to maximize the coefficient of correlation, and a temporally ordered relation between the data is specified on the basis of the temporal precedence relation obtained from the shift width. This point is explained with reference to FIGS. 5A and 5B. FIGS. 5A and 5B are drawings illustrating an example of month-shifted correlation. FIG. 5A is a drawing illustrating original waveforms, and FIG. 5B is a drawing illustrating a case where one waveform is shifted by one month. It is assumed, as illustrated in FIGS. 5A and 5B, that there is a relationship between a certain time-series data X (a waveform represented by a bold line) and other certain time-series data Y (a waveform represented by a thin line) such that, when the time-series data Y is shifted forward by one month, the cross-correlation coefficient between the time-series data X and Y reaches its maximum. This means that the time-series data Y temporally precedes the time-series data X by one month. Accordingly, a temporal precedence relation in which the time-series data Y precedes the time-series data X by one month is obtained. The stratification unit 150 also grasps such temporal precedence relations between other data, determines temporal relationships from the grasped temporal precedence relations, stratifies the plurality of groups D3 according to the determined temporal relationships, and outputs the result of the stratification. Similarly, in a case where the time-series dataset D2 is treated as a processing target, the stratification unit 150 determines temporal relationships between the plurality of pieces of time-series data included in the time-series dataset D2, stratifies the plurality of pieces of time-series data included in the time-series dataset D2 according to the determined temporal relationships, and outputs the result of the stratification.

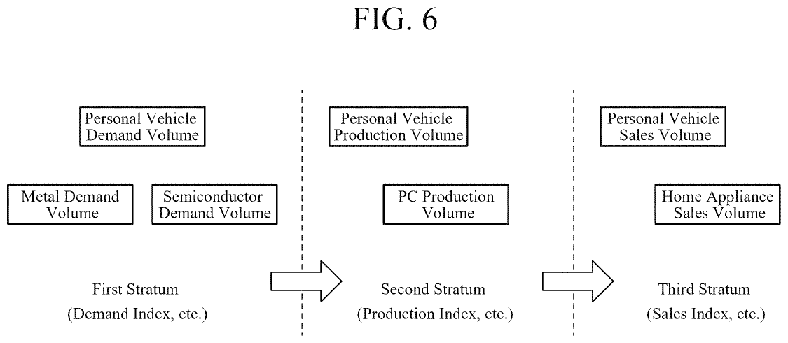

As another embodiment of stratification, for example, a temporally ordered relation defined using words, demand (demand)→production (production)→sales (sales), is preset according to domain knowledge. The domain knowledge is defined through user input and performed through user input. The preset domain knowledge includes a plurality of words and the definition of temporal relationships between the plurality of words. The stratification unit 150 acquires the set domain knowledge. The user input related to the presetting may be directly acquired by the stratification unit 150 or may be indirectly acquired via the data input unit 110. The stratification unit 150 stratifies data whose names include the words on the basis of the acquired temporal relationships. FIG. 6 is a drawing illustrating a specific example of a case where the stratification is performed according to preset temporal relationships. The stratification unit 150 acquires the preset temporal relationships, demand (demand)→production (production)→sales (sales), and stratifies the groups “personal vehicle demand volume,” “personal vehicle production volume,” “personal vehicle sales volume,” “metal demand volume,” “semiconductor demand volume,” “PC production volume,” and “home appliance sales volume” according to the temporal relationships. Since the groups “personal vehicle demand volume,” “metal demand volume,” and “semiconductor demand volume” include the term “demand,” the stratification unit 150 classifies the groups “personal vehicle demand volume,” “metal demand volume,” and “semiconductor demand volume” as belonging to the first stratum. Since the groups “personal vehicle production volume” and “PC production volume” include the term “production,” the stratification unit 150 classifies the groups “personal vehicle production volume” and “PC production volume” as belonging to the second stratum. Since the groups “personal vehicle sales volume” and “home appliance sales volume” include the term “sales,” the stratification unit 150 classifies the groups “personal vehicle sales volume” and “home appliance sales volume” as belonging to the third stratum.

Other than these, the stratification unit 150 may perform stratification using a Granger causality testing approach.

### (Visualization Unit)

The visualization unit 160 is a functional unit to generate a visualization diagram visualizing inter-group relationships using information about the groups D3 (including the name list D3-1 of data included in each group and the information D3-3 about the step order of each group) and the inter-group (semantic) relationships D4 (including the degrees of inter-group waveform similarity D4-1 and the temporal precedence relations D4-2 between the respective groups) in such a manner that a human can easily grasp the inter-group relationships, and output the generated visualization diagram.

In the first embodiment, for example, the visualization of the inter-group relationships is performed in the following manner. The visualization of the inter-group relations is executed in a graph format in which the respective groups (D3) are represented as vertices, and the inter-group relationships (D4) are represented as edges.

First, a stratified structure similar to the strata (D3-3) defined by the stratification unit 150 is prepared.

Next, each group is allocated to a stratum on the basis of the name list (D3-1) data included in the group. Each group is visualized as a vertex.

Next, the inter-group relationships are visualized on the basis of the information (D4-1) about the degree of inter-group waveform similarity. In the visualization, the groups, which are represented by the vertices, are connected by the edges that vary in nature such as line thickness, line color, or line type such as solid line or broken line, according to the strength/weakness of the relationships.

For example, the list, the name list (D3-1) of data included in each group, is made easily viewable by displaying the list in a list format when operation such as clicking is performed on a group at a vertex, and so on. Such operation and displaying is performed via unillustrated input and output devices. The visualization unit 160 acquires an instruction of operation input via the input device and performs display control to display on the output device.

### (Recalculation Unit)

After the series of the processes performed by the data input unit 110 to the visualization unit 160 is executed once, the recalculation unit 170 accepts additional time-series data D1-2 and performs a process for outputting a visualization diagram in which the accepted additional time-series data D1-2 has been added to the time-series dataset D1.

In the first embodiment, recalculation at the time when the additional time-series data D1-2 has been added is performed in the following manner. Note that the additional time-series data D1-2 has been stored on the storage device 300, and the recalculation unit 170 acquires the additional time-series data D1-2 from the storage device 300.

It is assumed here that the additional time-series data D1-2 is a single piece of time-series data. When a plurality of pieces of time-series data are added, processes of the following bullet points are performed on each piece of additional data, thereby appending content corresponding to the additional data to a visualization diagram having been generated.
The recalculation unit 170 supplies the additional time-series data D1-2 to the preprocessing unit 120.
The preprocessing unit 120 performs preprocessing on the additional time-series data D1-2.
The grouping unit 130 calculates the coefficients of cross-correlation between the additional time-series data D1-2 after having been subjected to the preprocessing and the plurality of groups D3 having already been generated. The calculation of the coefficients of cross-correlation may be performed by the same method as the method explained above.
In a case where there is data with a coefficient of cross-correlation which is equal to or greater than the predefined constant (D3-N1) set at the grouping unit 130, the grouping unit 130 chooses groups whose coefficient of cross-correlation is the greatest, and adds the additional time-series data D1-2 to the chosen group. That is, the grouping unit 130 adds the name of the additional data to the name list D3-1 of data included in the relevant group. The completion of this process completes the recalculation.
In a case where there is no data with a coefficient of correlation which is equal to or greater than the predefined constant (D3-N1) set at the grouping unit 130, the grouping unit 130 treats the additional time-series data D1-2 as one independent group. Subsequently, the relationship calculation unit 140 performs calculation of relationships between the group of the additional time-series data D1-2, which is a single group, and other groups D3. On the basis of the result, the visualization unit 160 updates the visualization diagram and completes the recalculation.

Note that, instead of the method including the bullet points described above, the recalculation process may be performed by a different method. The different method is specifically as follows. The recalculation unit 170 merges the additional time-series data D1-2 and the original time-series dataset D1 to generate a time-series dataset D1-3. The recalculation unit 170 supplies the generated time-series dataset D1-3 to the preprocessing unit 120. By performing the process performed by the preprocessing unit 120 through to the process performed by the visualization unit 160 on the time-series dataset D1-3, a visualization diagram is generated newly afresh. The selection of either of the methods is performed on the basis of user input.

### (Hardware)

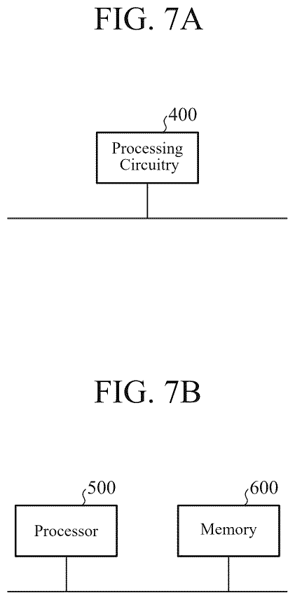

Next, a configuration example of the hardware of the time-series data processing device 100 is explained with reference to FIGS. 7A and 7B. Respective functions of the time-series data processing device 100 are implemented by processing circuitry (processing circuitry). The processing circuitry (processing circuitry) may be a dedicated processing circuit (processing circuit) 400 illustrated in FIG. 7A or a processor 500 to execute programs stored on a memory 600 illustrated in FIG. 7B.

In a case where the processing circuitry (processing circuitry) is the dedicated processing circuit 400, for example, the dedicated processing circuit 400 is a single circuit, a composite circuit, a programmed processor, a parallel-programmed processor, an application specific integrated circuit (ASIC), a field-programmable gate array (FPGA), or a combination of these. Functions of the time-series data processing device 100 may be implemented by a plurality of separate processing circuits (processing circuits), or functions of the time-series data processing device 100 may be collectively implemented by a single processing circuit (processing circuit).

In a case where the processing circuitry (processing circuitry) is the processor 500, functions of the time-series data processing device 100 are implemented by software, firmware, or a combination of software and firmware. The software and the firmware are written as programs, and stored on the memory 600. The processor 500 reads out and executes a program stored on the memory 600, thereby implementing a function of the time-series data processing device 100. Here, examples of the memory 600 include a non-volatile or volatile semiconductor memory such as a random access memory (RAM), a read-only memory (ROM), a flash memory, an erasable programmable read only memory (EPROM), or an electrically erasable programmable read-only memory (EEPROM), a magnetic disk, a flexible disc, an optical disc, a compact disc, a mini disc, and a DVD. The memory 600 may be implemented as the same device as the storage device 200 or the storage device 300.

Note that some of the functions of the time-series data processing device 100 may be implemented by dedicated hardware, and the other functions may be implemented by software or firmware. In this manner, the processing circuitry can implement the functions of the time-series data processing device 100 by hardware, software, firmware, or a combination of these.

### <Operation>

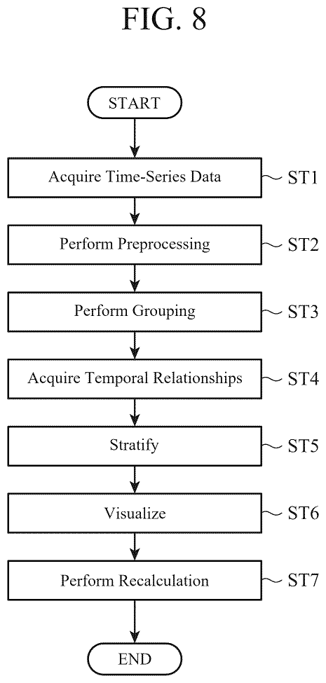

Next, an operation performed by the time-series data processing device 100 is explained with reference to FIG. 8.

### (Step ST1)

First, at Step ST1, the data input unit 110 acquires the time-series dataset D1 including explanatory-variable candidates to be used for prediction.

### (Step ST2)

Next, at Step ST2, the preprocessing unit 120 performs preprocessing on the time-series dataset D1 acquired at the data input unit 110. The preprocessing unit 120 supplies, to the grouping unit 130, the time-series dataset D2 obtained after the preprocessing is performed on the time-series dataset D1.

### (Step ST3)

Next, at Step ST3, the grouping unit 130 classifies and groups the acquired time-series dataset D2 according to the degrees of similarity between the nature of the respective pieces of data.

### (Step ST4)

Next, at Step ST4, the relationship calculation unit 140 calculates inter-group relationships. In addition, the relationship calculation unit 140 acquires temporal relationships between the groups by comparison of the waveforms.

### (Step ST5)

Next, at Step ST5, the stratification unit 150 determines temporal relationships on the basis of the step order of various activities or statistical analysis such as month-shifted correlation and stratifies the groups on the basis of the determined temporal relationships.

### (Step ST6)

Next, at Step ST6, the visualization unit 160 stratifically visualizes the inter-group relationships obtained at Step ST4 on the basis of the temporal relationships obtained at Step ST5.

### (Step ST7)

After the series of processing at Steps ST1 to ST6 is performed, the recalculation unit 170 performs recalculation of relationships in order to add additional time-series data to the existing groups and visualize them. When the time-series data is added, the recalculation of relationships can be performed while keeping time cost low, by comparing the additional data and the existing groups.

### Advantageous Effects

In order to select explanatory variables that are convincing to a user in the prediction of indicators in economic activities, manual assessment is essential in the end. However, it is extremely difficult to manually select explanatory variables which are valid both in terms of domain knowledge and statistically from such a large number of pieces of data.

Due to a visualization diagram representing relationships output by the time-series data processing device 100 according to the present disclosure, it is possible to extract several candidates as statistically valid explanatory variables from a large number of pieces of data. By extracting a plurality of candidates in this manner, the number of targets on which a human performs selection/elimination on the basis of domain knowledge can be reduced. Thereby, it becomes easier for the human her/himself who performs prediction to select/eliminate explanatory variables. Accordingly, it becomes possible to incorporate domain knowledge of the human while ensuring the statistical usefulness of explanatory variables to be used for the prediction. Accordingly, the sense of distrust in the prediction obtained from the explanatory variables can be reduced, and the convincingness of the prediction can be enhanced.

### Implementation Example

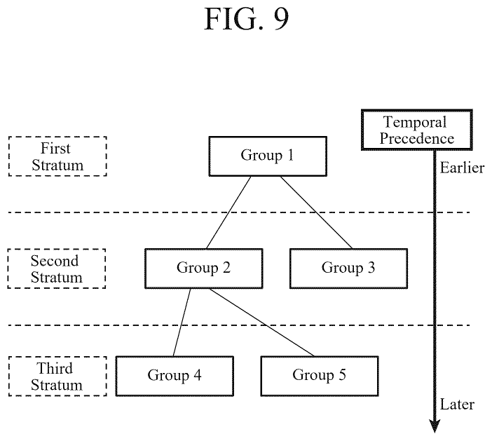

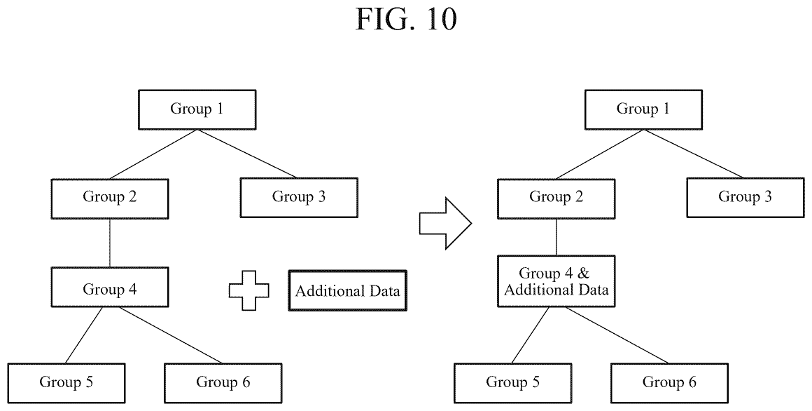

Hereinbelow, a more specific implementation example of the time-series data processing device 100 is explained. For example, a visualization diagram representing relationships output by the time-series data processing device 100 is illustrated in FIG. 9. In FIG. 9, each vertex represents a group of similar time-series data, and each edge linking vertices represents the strength of an inter-group relationship. In addition, a plurality of strata in FIG. 9 are strata distinguished according to temporal relations, and FIG. 9 illustrates that groups positioned in higher strata temporally precede groups positioned in lower strata.

As an example, a case where the future trend of data “air conditioner shipment volume” included in the group 2 in FIG. 9 is predicted is considered.

### (First Step)

From the information about the inter-data relationships in FIG. 9, it can be inferred that the group 2 to which the data “air conditioner shipment volume” belongs has strong relationships with the groups 1, 4, and 5. Thereby, it is possible to narrow down the candidate explanatory variables to data included in any of the groups 1, 4, and 5 as useful ones to be used when the data “air conditioner shipment volume” is predicted.

### (Second Step)

From the information about the strata in FIG. 9, it can be inferred that, from among the groups (1, 4, and 5) to which the candidates have been narrowed down at the first step, only the group 1 temporally precedes the group 2 to which the data “air conditioner shipment volume” belongs. Thereby, it is possible to narrow down the candidate explanatory variables to data included in the group 1 as a useful one to be used when the data “air conditioner shipment volume” is predicted. When certain data Y is predicted, if there is other data X that temporally precedes the data Y, the data X is an explanatory variable (preceding indicator) that is useful in the prediction of the data Y.

### (Third Step)

It is assumed that, as the information about the groups in FIG. 9, it can be inferred that the data “number of new building construction starts,” “amount of apple consumption,” and “mackerel harvest amount” belong to the groups of the explanatory-variable candidates to which the candidates have been narrowed down at the second step. The data “number of new building construction starts,” “amount of apple consumption,” and “mackerel harvest amount” are presented as final explanatory-variable candidates to the user.

### (Fourth Step)

The user selects, from among the explanatory-variable candidate data “number of new building construction starts,” “amount of apple consumption,” and “mackerel harvest amount,” data which is the most convincing when used for prediction. For example, there is a causal relation that is easy to grasp intuitively between the data “air conditioner shipment volume” and the data “number of new building construction starts” for the reason that “The number of buildings increases. →The demand for air conditioners to be newly installed in the buildings increases. →The air conditioner shipment volume increases.” Accordingly, the user can easily select “number of new building construction starts” as an explanatory variable to be used for the prediction of “air conditioner shipment volume.” By performing the prediction using data that has a causal relation that is easy to grasp intuitively in this manner, it is possible to obtain prediction results that are convincing to the user.

By grouping explanatory variables at the grouping unit 130, the number of factors that appear on the visualization diagram can be reduced. As a result, it is possible to narrow down explanatory-variable candidates stepwise, and efforts that are required when the selection/elimination of explanatory variables is performed can be reduced.

By visualizing the relationships between explanatory-variable candidates, the selection/elimination of explanatory variables, which has conventionally relied on domain knowledge or tacit knowledge of experts, can be executed without relying on the skills of humans.

When explanatory-variable candidate data or prediction-target data is added, the allocation of the additional data to existing groups according to the process performed by the recalculation unit 170 by grouping explanatory variables at the grouping unit 130 eliminates the need to perform grouping, relationship calculation, and visualization again and can reduce the time cost required for re-outputting the visualization diagram.

Note that embodiments can be combined, and each embodiment can be modified or omitted as appropriate.

### INDUSTRIAL APPLICABILITY

The time-series data processing device according to the present disclosure can be used as a device to predict data related to indicators such as the air conditioner shipment volume.

### REFERENCE SIGNS LIST

100: Time-series data processing device, 110: Data input unit, 120: Preprocessing unit, 130: Grouping unit, 140: Relationship calculation unit, 150: Stratification unit, 160: Visualization unit, 170: Recalculation unit, 200: Storage device, 300: Storage device, 400: Processing circuitry, 500: Processor, 600: Memory

1. A time-series data processing device comprising:
processing circuitry
to acquire a first time-series dataset including a plurality of pieces of time-series data to be treated as explanatory-variable candidates;
to convert the acquired first time-series dataset into a format capable of calculating relationships between the plurality of pieces of time-series data included in the first time-series dataset, and generate a second time-series dataset including the plurality of pieces of time-series data after the conversion;
to calculate waveform and semantic relationships between the plurality of pieces of time-series data included in the second time-series dataset;
to determine temporal relationships between the plurality of pieces of time-series data included in the second time-series dataset, stratify the plurality of pieces of time-series data included in the second time-series dataset according to the determined temporal relationships, and output a result of the stratification; and
to generate a visualization diagram visualizing the plurality of pieces of time-series data included in the second time-series dataset on a basis of the calculated waveform and semantic relationships and the output result of the stratification.

2. The time-series data processing device according to claim 1, wherein the processing circuitry determines the temporal relationships between the plurality of pieces of time-series data included in the second time-series dataset according to domain knowledge defined by user input.

3. The time-series data processing device according to claim 2, wherein the domain knowledge includes a plurality of words and a definition of temporal relationships between the plurality of words.

4. The time-series data processing device according to claim 1, wherein the processing circuitry performs time shifting in such a manner that coefficients of correlation between the plurality of pieces of time-series data included in the second time-series dataset are maximized, determines shift widths, and determines temporal relationships between the plurality of pieces of time-series data included in the second time-series dataset from the determined shift widths.

5. The time-series data processing device according to claim 1, wherein the waveform and semantic relationships are cross-correlation between the plurality of pieces of time-series data included in the second time-series dataset.

6. The time-series data processing device according to claim 1, wherein the visualization diagram is a graph in which each time-series data of the plurality of pieces of time-series data included in the second time-series dataset is represented as a vertex, and the waveform and semantic relationships between the plurality of pieces of time-series data are represented as edges.

7. The time-series data processing device according to claim 6, wherein the edges vary in line thickness, line color, or line type such as solid line or broken line according to the waveform and semantic relationships between the plurality of pieces of time-series data included in the second time-series dataset.

8. The time-series data processing device according to claim 1, wherein the processing circuitry classifies the plurality of pieces of time-series data included in the second time-series dataset into groups according to nature of the plurality of pieces of time-series data and generate a representative value of each group.

9. The time-series data processing device according to claim 8, wherein the processing circuitry performs grouping of the plurality of pieces of time-series data included in the second time-series dataset according to degrees of similarity between waveforms of the plurality of pieces of time-series data included in the second time-series dataset.

10. The time-series data processing device according to claim 8, wherein, for each group, the processing circuitry generates a representative value reflecting a feature of data included in the group.

11. The time-series data processing device according to claim 1, wherein the processing circuitry to accept additional time-series data and perform recalculation for adding the accepted additional time-series data to the visualization diagram.

12. The time-series data processing device according to claim 11, wherein the processing circuitry determines a representative value of the accepted additional time-series data, calculates a coefficient of correlation between the determined representative value of the accepted additional time-series data and the generated representative value of each group, and allocates the accepted additional time-series data to a group whose calculated coefficient of correlation is largest.

13. The time-series data processing device according to claim 11, wherein the processing circuitry determines a representative value of the accepted additional time-series data, calculates a coefficient of correlation between the determined representative value of the accepted additional time-series data and the generated representative value of each group, generates a new group including the accepted additional time-series data in a case where none of the calculated coefficients of correlation are lower than a predetermined threshold value, and calculates waveform and semantic relationships and temporal relationships between the generated new group and other groups.

14. A time-series data processing method comprising:
acquiring a first time-series dataset including a plurality of pieces of time-series data to be treated as explanatory-variable candidates;
converting the acquired first time-series dataset into a format capable of calculating relationships between the plurality of pieces of time-series data included in the first time-series dataset, and generating a second time-series dataset including the plurality of pieces of time-series data after the conversion;
calculating waveform and semantic relationships between the plurality of pieces of time-series data included in the second time-series dataset;
determining temporal relationships between the plurality of pieces of time-series data included in the second time-series dataset, stratifying the plurality of pieces of time-series data included in the second time-series dataset according to the determined temporal relationships, and outputting a result of the stratification; and
generating a visualization diagram visualizing the plurality of pieces of time-series data included in the second time-series dataset on a basis of the calculated waveform and semantic relationships and the output result of the stratification.
